(19) United States
(12) Patent Application Publication
(10) Pub. No.: US 2003/0038019 A1
(43) Pub. Date: Feb. 27, 2003

(54) Steering column stalk having multiple switch cells

(75) Inventors: James B. Wright, Sterling Heights, MI (US); Owen D. Winkler, Westland, MI (US); Steven A. Liburdi, Clinton Township, MI (US); Jeffrey K. Wiersing, Walled Lake, MI (US); Gary John Dembinski, Wixom, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: Lear Corporation, Southfield, MI

(21) Appl. No.: 09/934,018

(22) Filed: Aug. 21, 2001

(51) Int. Cl. H01H 9/00

(52) U.S. Cl. 200/61.54

(57) ABSTRACT

A vehicle steering column stalk switch assembly is provided having at least one enclosed switch cell unit used in lieu of metal connector contacts. More particularly, one or more enclosed switch cell units are used in place of conventional all-opened or exposed switch contacts. A switch cell is connected to a printed circuit board within the stalk switch assembly, and positioned for actuation upon movement of a corresponding actuating member of a stalk switch lever. Various switch cells can be positioned so that movement of the lever or knob on the lever in a particular direction will selectively control operation of different vehicle devices or functions.

### TECHNICAL FIELD

The present invention generally relates to multi-function steering column stalk switching arrangements, and more particularly to a steering column stalk switching arrangement which is less susceptible to environmental contamination as well as minimizes tooling requirements.

### BACKGROUND ART

Generally, steering column stalk switching arrangements are utilized in vehicles to control a multitude of functions, such as a turn signal, wiper, headlamp, beam selection, hazard lights, and windshield washing. Control of each of these functions is typically performed by tooling into the stalk assembly design dedicated metal contact arrangements which are closed or opened depending on movement of the stalk by the driver.

The problem generally encountered by such arrangements is that the metal contact arrangements tooled into the stalk assembly are highly susceptible to environmental contamination such as from dust or other foreign particles working their way into the stalk assembly housing. In addition, the need for metal contacts within the stalk switch assembly housing significantly increases tooling costs and assembly complexity. Therefore, a need exists for a steering column stalk switch assembly which reduces susceptibility of the switch contacts to environmental contamination, while also reducing tooling cost and assembly complexity.

### DISCLOSURE OF INVENTION

It is therefore an object of the present invention to provide a steering column stalk switch assembly which solves the afore stated problems by utilizing one or more enclosed switch cell devices.

It is another object of the present invention to provide a vehicle steering column stalk switch assembly which utilizes an enclosed switch cell unit positioned within the assembly so as to be actuated by movement of a lever or knob incorporated into the stalk.

Therefore, in accordance with one aspect of the present invention, a multifunction steering column stalk switch assembly is provided having a housing and a stalk lever pivotally mounted to a stationary base portion to allow the stalk lever to move about at least one pivot axis. The stalk lever includes a switch actuating member. A circuit board is disposed in the housing, and at least one enclosed switch cell is mounted to the circuit board and positioned relative to the stalk lever so that movement of the stalk lever in a particular direction will bring the switch actuating member into contact with an actuator member on the switch cell so as to actuate the switch cell. The circuit board includes an output circuit for generating a function control signal in response to actuation of the at least one switch cell.

The above objects and other objects, features, and advantages of the present invention are readily apparent from the following detailed description of the best mode for carrying out the invention when taken in connection with the accompanying drawings.

### BRIEF DESCRIPTION OF DRAWINGS

FIG. 1 is an exploded, elevated perspective view of a vehicle steering column stalk switch assembly in accordance with the present invention;

FIG. 2 is an elevated perspective view of a wiper function switch cell in isolation;

FIG. 3 is an elevated perspective view of a wash function switch cell shown in conjunction with an actuating lever;

FIG. 4 is an elevated perspective exploded view of a base portion of the steering column stalk switch assembly of FIG. 1;

FIG. 5 is an elevated perspective view of a headlamp beam select function switch cell shown in isolation;

FIG. 6 is an elevated perspective view of a turn signal function switch cell and rotating actuator in isolation;

FIG. 7 is an elevated exploded perspective view of a hazard light function switch cell and hazard button shown in isolation;

FIG. 8 is an exploded perspective view of the stalk lever assembly; and

FIG. 9 is a cross-section of a stalk lever showing a front wiper and wash switch cell and a rear wiper/wash switch cell.

### BEST MODE FOR CARRYING OUT THE INVENTION

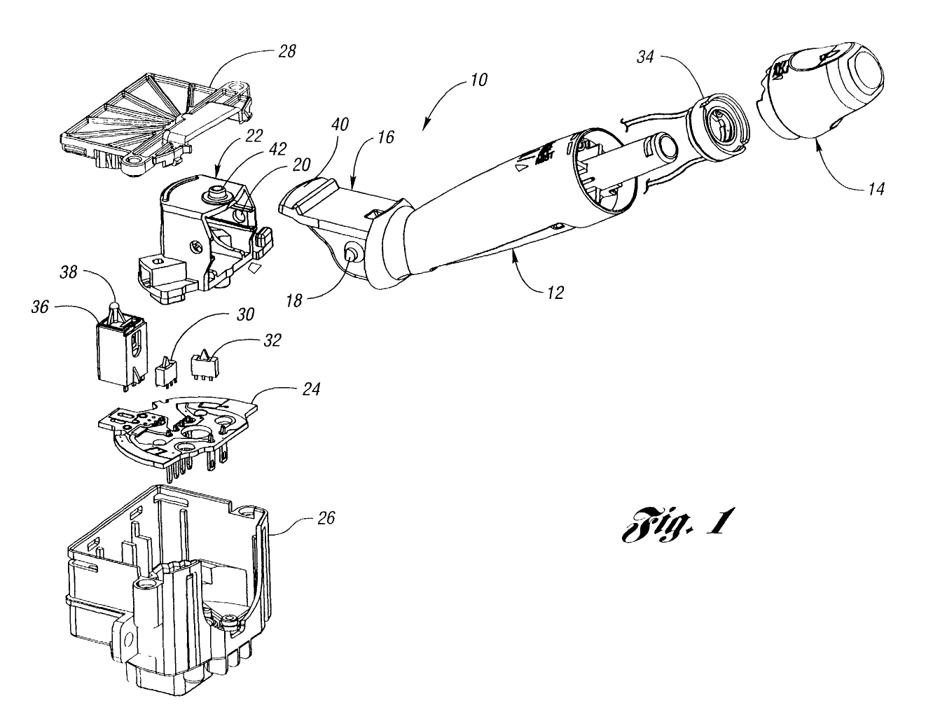

Referring to FIG. 1, a vehicle steering column stalk switch assembly 10 is shown in accordance with exemplary embodiment of the present invention. More specifically, FIG. 1 illustrates an exploded view of a stalk lever 12 having a rotating turn knob 14 coupled to the outer end thereof, and an actuator/pivoting base portion 16. Base portion assembly 16 includes a pair of pivot pins 18 (only one can be seen in FIG. 1) which nest within holes 20 formed in a stationary stalk base housing 22. Stationary stalk base housing 22 mates with a printed circuit board 24 which then nests within an outer base housing 26. An outer cover 28 fastens to base portion 26 upon assembly to hold the printed circuit board and stationary stalk base housing in place.

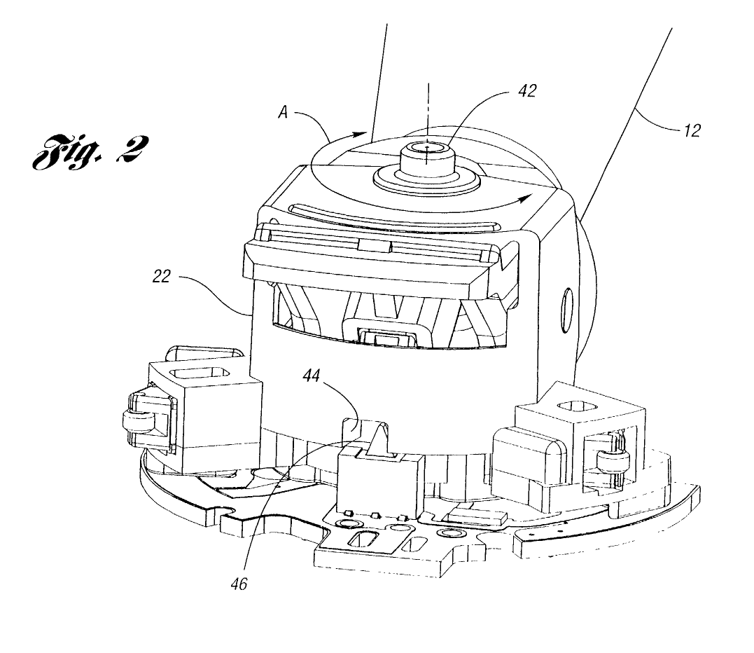

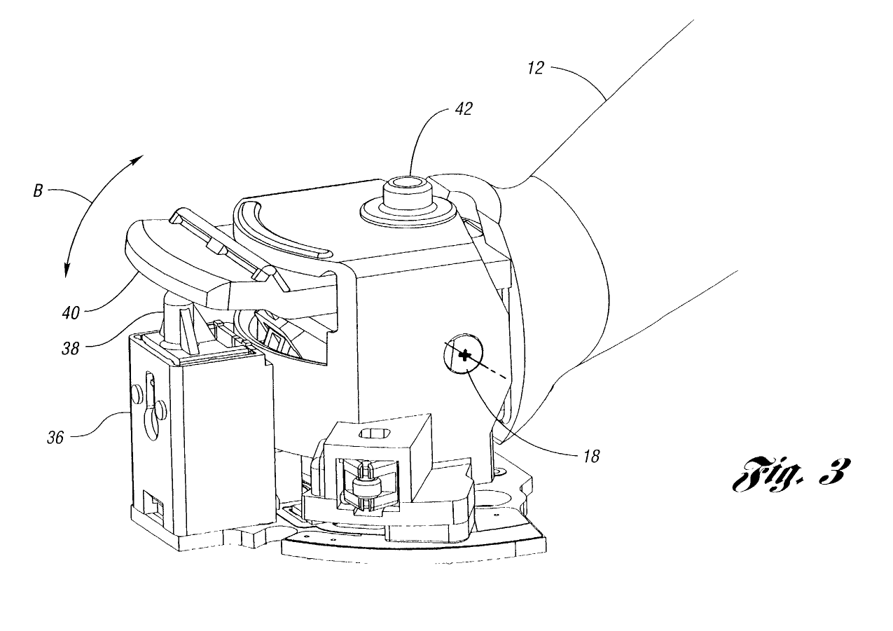

In accordance with the present invention, at least one enclosed switch cell unit is used in lieu of metal connector contacts. More particularly, the present invention utilizes an enclosed switch cell unit in place of all opened or exposed switch contacts as typically employed in conventional stalk switch assemblies. As shown in FIG. 1, a pair of wiper function switch cells 30 and 32 are connected to printed circuit board 24, such as by soldering, and positioned for actuation upon movement of a corresponding member of the stalk switch lever. An intermittent wiper speed control switch cell 34 is mounted within lever 12 so as to be actuated upon rotation of end element 14. A washer function switch cell 36 is mounted to printed circuit board 24 and positioned so that a push member 38 is actuated by a pivot arm actuator 40 on stalk lever 12. Positioning of the wiper function switch cell and the washer function switch cell are shown in more detail in FIGS. 2 and 3, respectively.

More specifically, referring now to FIG. 2 stalk lever 12 is shown assembled to stationary base housing 22 and printed circuit board 24 with washer function switch cell 36 removed for clarity. As shown, stalk lever 12 is rotatable about a pin 42 so as to cause housing 22 to rotate. Base housing 22 is formed with a notch 44 that fits over a switch cell actuator 46 such that movement of housing 22 will cause one side of the notch to come into contact with actuator 46 to actuate the switch cell. Rotation of housing 22 is generally denoted by arrow A.

Referring now to FIG. 3, washer function switch cell 36 is shown mounted and positioned on printed circuit board 24 such that pivoting of lever 12 about pins 18 as denoted by arrow B causes actuator arm 40 to engage and push down actuator arm 38 on switch cell 36. Thus, pivoting of lever 12 in the manner shown by arrow B opens and closes switch cell 36 so as to control a windshield washer pump motor (not shown).

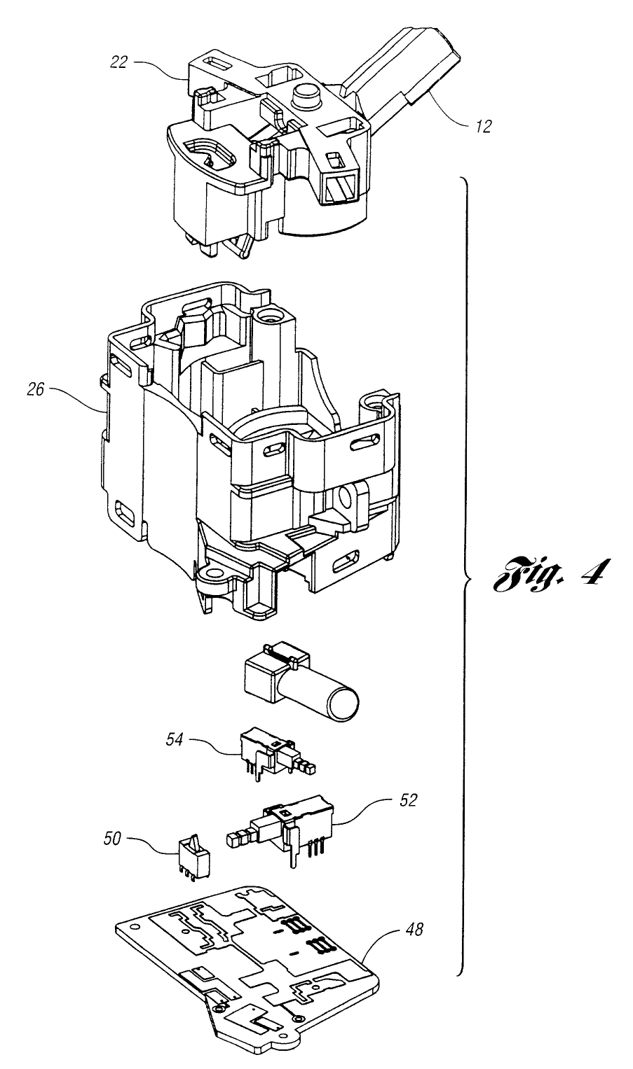

Referring now to FIG. 4, an exploded view is shown of base housing assembly 26. More specifically, base housing 26 is assembled with a printed circuit board 48 such that various switch cells mounted to printed circuit board 48 are positioned so as to be actuated by appropriate movement of stalk lever 12. In this embodiment, a turn signal function switch cell 50, a headlamp beam selector function switch cell 52, and a hazard light function switch cell 54 are each mounted so that appropriate movement of lever 12, or a separate actuator switch causes actuation of a switch cell actuator to control operation of the corresponding vehicle device.

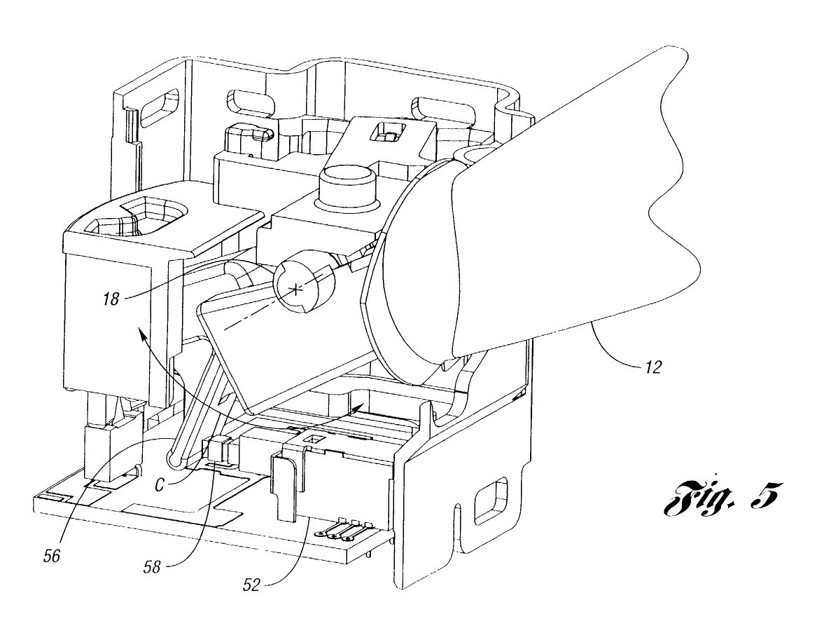

As best seen in FIG. 5, base portion 16 of lever 12 includes an extension member 56 that is arranged to make contact with a switch cell actuator 58 on headlamp beam selector function switch cell 52. As stalk lever 12 is pivoted about pin 18 in the direction denoted by arrow C, extension member 56 either engages actuator 58 to close or open the switch cell as desired.

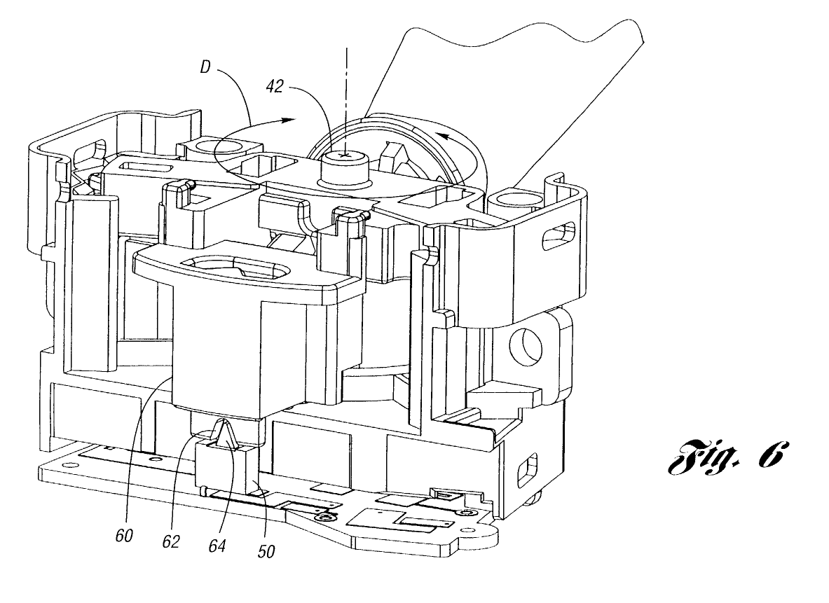

Referring now to FIG. 6, base coupling portion 22 includes an integrated actuator element 60 formed with a notch 62 that fits about an actuator arm 64 on turn signal function switch cell 50 as stalk lever 12 is moved as to pivotly rotate member 22 about pin 42 in the direction of arrow D, one side of notch 62 is brought into engagement with actuator element 64 so as to open and close switch cell 50 to control operation of a desired turn signal indicator.

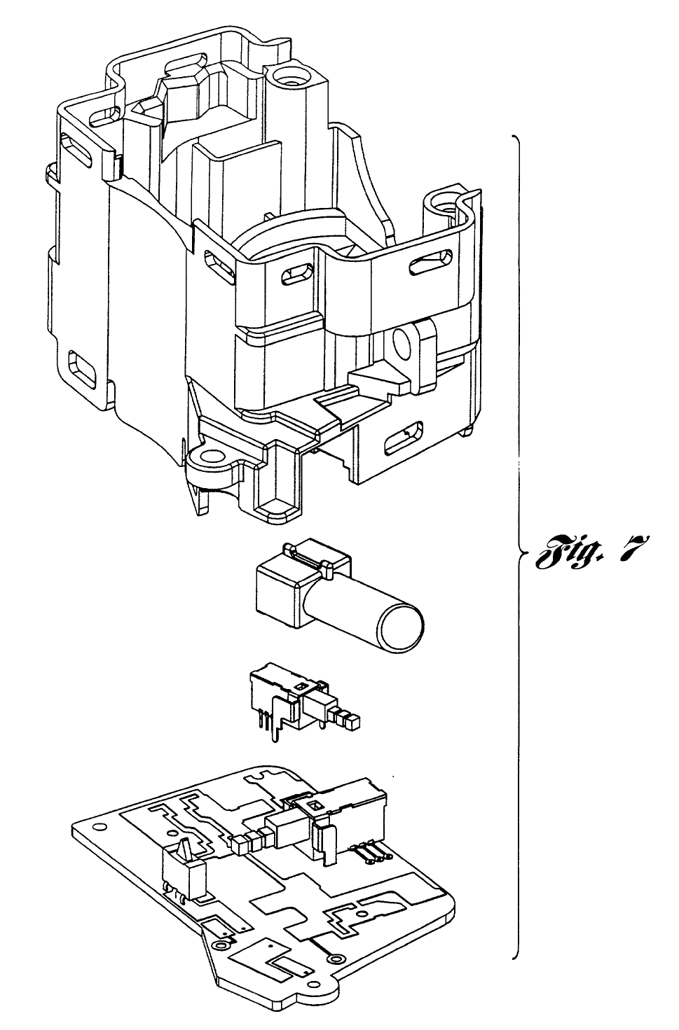

Referring now to FIG. 7, the base housing is formed with a slide passage 66 which is arranged to accommodate a slidable hazard pushbutton 68. The hazard pushbutton is arranged to slide in and out of the base housing so as to engage an actuator button 70 located on the hazard function switch cell. Movement of the hazard slide button is denoted by arrow E. As the hazard pushbutton is slid in and out, it engages the actuator button on the hazard function switch cell to close and open the hazard light circuit (not shown) to control operation of the hazard lights on the vehicle. The hazard slide button can include a suitable latching, day taunt, or spring biasing mechanism that maintains the slide button in the respective on and off positions.

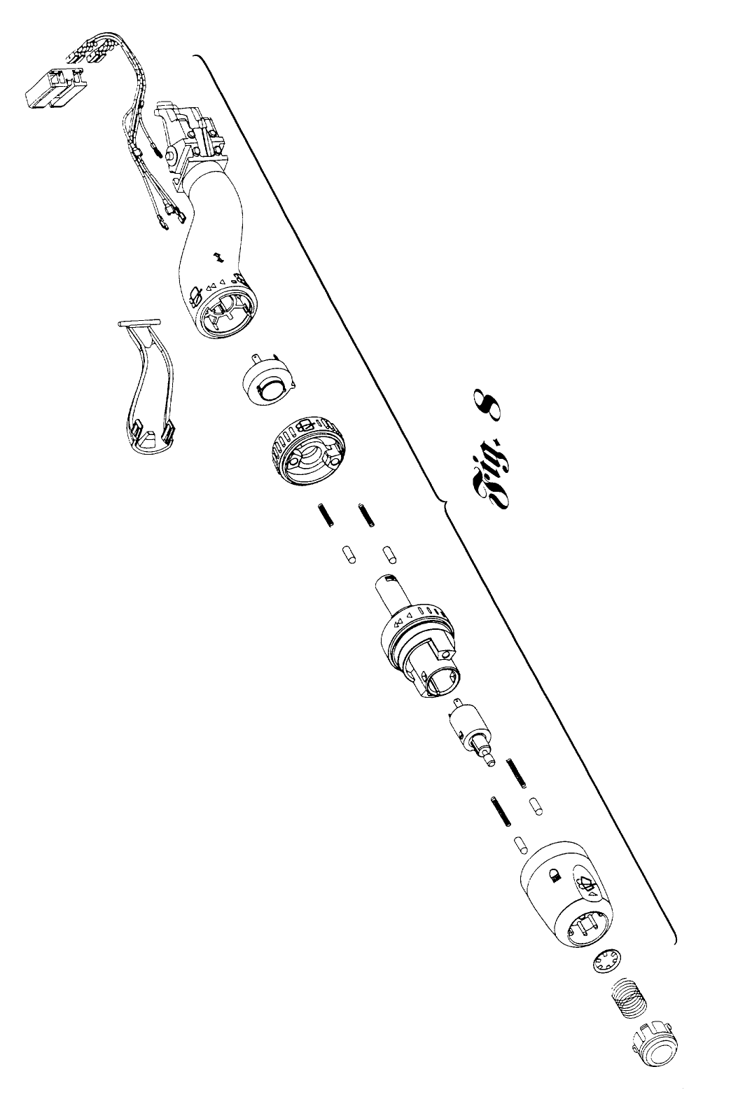

Referring now to FIG. 8, a further embodiment of a switch stalk lever 100 is shown in exploded view. In this embodiment, a rotatable dial member 102 attaches to the outer end of the lever arm 104, and is at range to received a closure member 106 having a spring loaded pushbutton 108 mounted therein. The closure member connects to a second rotary dial member 110 which has an elongated actuator arm arranged to pass through an opening 112 in the first rotatable member when assembled. Rotatable member 110 further includes a switch cell chamber 114 arranged to receive a front window wiper/washer switch cell 116 therein. A rear window wiper/washer switch cell 118 is positioned in an opening at the end of the stalk lever so as to be engaged by the end of the elongated actuator arm on the second rotatable member. A set of pegs 120 and springs 122 are arranged to nest within corresponding slots in the second rotatable member so as to maintain the closure member and the second rotatable member in proper alignment while also allowing the closure member to move in and out in the direction of arrow F. Likewise, a set of pins 28 and springs 30 nest within slots 132 of the first rotatable member so as to lock the second and first rotatable members in alignment while allowing the second rotatable member to be separately moved in and out in the direction of arrow F. The two switch cells connect to an appropriate wiring harness 134 extending through stalk lever 104. The stalk lever is shown with a removable outer piece 136 to facilitate assembly.

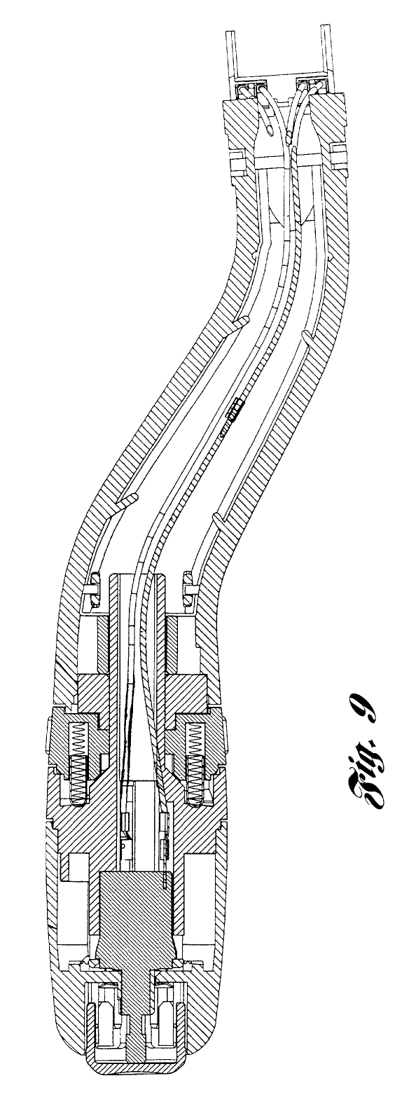

As shown, the outer spring bias pushbutton in the closure member can be engaged so as to actuate a pushbutton arm 138 on the front wiper/washer switch cell to control operation of washer pump. Rotation of the second rotating member causes the front wiper/washer switch cell to move into multiple switch connection positions as shown by arrow G to control operation of the front wiper motor. Likewise, axial movement along arrow E of the second rotation member causes the elongated actuator arm to actuate the rear wiper/washer switch cell to control operation of a rear washer pump. Rotation of the first rotating member about arrow H causes actuation of the rear wiper/washer switch cell to control selective operation of a rear wiper motor. Assembly of embodiment 100 is shown in cross-section in FIG. 9. It is noted that while the detent pins, plungers, and springs, are shown as separate elements, such devices could be alternatively incorporated into the respective switch cells.

Thus, in accordance with the present invention each of the various functions of a steering column stalk lever switch assembly can be controlled using enclosed switch cells. With such an arrangement, the present invention is able to advantageously limit the risk of environmental contamination of the switches, while simplifying tooling and assembly of the stalk lever by allowing off the shelf type preassembled switch cells to be mounted into appropriate locations.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A multifunction steering column stalk switch assembly for selectively controlling operation of a plurality of different devices on the vehicle, the stalk switch assembly comprising:
a housing;
a stalk lever pivotally mounted to a stationary base portion to allow the stalk lever to move about at least one pivot axis, said stalk lever including a switch actuating member;
a circuit board disposed in the housing;
at least one enclosed switch cell mounted to the circuit board and positioned relative to the stalk lever so that movement of the stalk lever in a particular direction will bring the switch actuating member into contact with an actuator member on the switch cell so as to actuate the switch cell, wherein the circuit board includes an output circuit for generating a function control signal in response to actuation of the at least one switch cell.

2. The stalk switch assembly of claim 1 further comprising a plurality of enclosed switch cells mounted in different locations on the circuit board, the stalk lever including a plurality of switch actuating members positioned thereon so as to selectively actuate a particular one of the plurality of switch cells based on the direction of movement of the stalk lever.

3. The stalk switch assembly of claim 1 wherein the circuit controls operation of an interior dome light in response to actuation of the at least one switch cell.

4. The stalk switch assembly of claim 1 wherein the circuit controls operation of one or more vehicle headlamps in response to actuation of the at least one switch cell.

5. The stalk switch assembly of claim 1 wherein the circuit controls operation of a wiper motor in response to actuation of the at least one switch cell.

6. The stalk switch assembly of claim 1 wherein the circuit controls operation of a window washer in response to actuation of the at least one switch cell.
